(19) United States
(12) Patent Application Publication
(10) Pub. No.: US 2014/0211248 A1
(43) Pub. Date: Jul. 31, 2014

(54) WEB SERVER APPARATUS, CONTROL METHOD, AND PROGRAM THEREFOR

(71) Applicant: CANON KABUSHIKI KAISHA, Tokyo (JP)

(72) Inventor: Shinichi Uchikawa, Kawasaki-shi (JP)

(73) Assignee: CANON KABUSHIKI KAISHA, Tokyo (JP)

(21) Appl. No.: 14/160,411

(22) Filed: Jan. 21, 2014

(30) Foreign Application Priority Data
Jan. 28, 2013 (JP) 2013-013324

(51) Int. Cl. G06F 3/12; H04L 29/08

(52) U.S. Cl. CPC G06F 3/1287; H04L 67/02; H04L 67/16
USPC 358/1.15

(57) ABSTRACT

If a web service transmits a registration request to a web server apparatus, and if the same URL as the URL received from the web service is already registered in a web service management table of the web server apparatus, the web server apparatus registers the web server in the web service management table after determining that the extension determination condition received from the web service is not the same as an extension determination condition registered in the web service management table.

### BACKGROUND

1. Field

The present subject matter relates to a web server apparatus for processing a request for use of an Internet printing protocol (IPP) service, a method for controlling the web server apparatus, and a program therefor.

2. Description of the Related Art

The number of systems for operating a plurality of web services on a single web server has been continuously increasing. For example, in a printer, web-based printing services such as a device setting and management service (hereinafter referred to as Remote User Interface (UI)), an IPP service, and web services on devices (WSD) are operated on a single web server.

In order to operate a plurality of web services on a single web server, a unique uniform resource locator (URL) needs to be allocated to each of the web services. This is because when the web server receives a request to use a web service operated on the web server, the web server needs to determine which web service the request should be transmitted to for execution, based on the URL information included in an HTTP header of the request data.

Accordingly, the web services and the URLs need to be associated with each other on a one-to-one basis. Thus, the system has conventionally been required to be constructed such that a unique URL is allocated to each of the web services to be provided in a device.

Moreover, Japanese Laid-Open Patent Application No. 2008-176789 discusses a technique for registering only the application path of the URL to reduce the loads on the web server.

### SUMMARY

According to an aspect of the present subject matter, a web server apparatus includes a reception unit configured to receive a registration request from a web service and receive a URL and an extension determination condition used to identify the web service, a registration unit configured to, if the same URL as the received URL is already registered in a web service management table, register in the web service management table a correspondence between the received URL and the received extension determination condition and a function for calling the web service in association with each other as information of the web service that has transmitted the registration request, after determining that the received extension determination condition is not the same as an extension determination condition registered in the web service management table, and a request unit configured to, if a request is received and if the same correspondence as a correspondence between a URL and an extension determination condition included in the request is registered in the web service management table, call a web service for processing the request by using a function registered in association with the correspondence.

Further features of the present subject matter will become apparent from the following description of exemplary embodiments with reference to the attached drawings.

### BRIEF DESCRIPTION OF THE DRAWINGS

FIG. 1 is a diagram illustrating a system configuration according to a first exemplary embodiment of the present subject matter.

FIG. 2 is a diagram illustrating a hardware configuration of a web server apparatus.

FIG. 3 is a diagram illustrating a configuration of an internal module of a web server.

FIG. 4 is a diagram illustrating a configuration of an internal module of a web service.

FIGS. 5A, 5B, 5C, and 5D are example web service management table(s).

FIG. 6 is a flowchart illustrating processing executed by a web service registration unit.

FIG. 7 is a flowchart illustrating processing executed by a web service registration processing unit.

FIG. 8 is a flowchart illustrating processing executed by a web service determination unit.

FIGS. 9A, 9B, and 9C are examples of request data transmitted to the web server or each web service.

### DESCRIPTION OF THE EMBODIMENTS

There are cases where the same URL is desired to be used for a plurality of web services operated on a single web server. For example, an “http://Internet protocol (IP) address/” path for specifying an image forming apparatus, and a hypertext transfer protocol (HTTP) path including a single IP address for specifying a web service are defined to simplify a user input. If the user knows such a path, the user can use the service by using a route path (“/”). This allows the user to use the web service simply by remembering the IP address, thereby providing high usability. Thus, a single URL is used for different web services, so that a user does not need to remember the URL of each of the web services.

However, since such a technique provides one-to-many correspondence between the URL and the web services, the web server cannot identify which web service a request should be transmitted to in response to a received URL.

The present subject matter is directed to a web server apparatus that allows a web server to identify which web service to call according to a received HTTP request if a plurality of web services having the same URL operates on a single web server.

Various exemplary embodiments, features, and aspects of the subject matter will be described in detail below with reference to the drawings.

In a first exemplary embodiment of the present subject matter, a web server function will be described, which allows a web server to identify which web service should process a request even if a plurality of web services has the same URL.

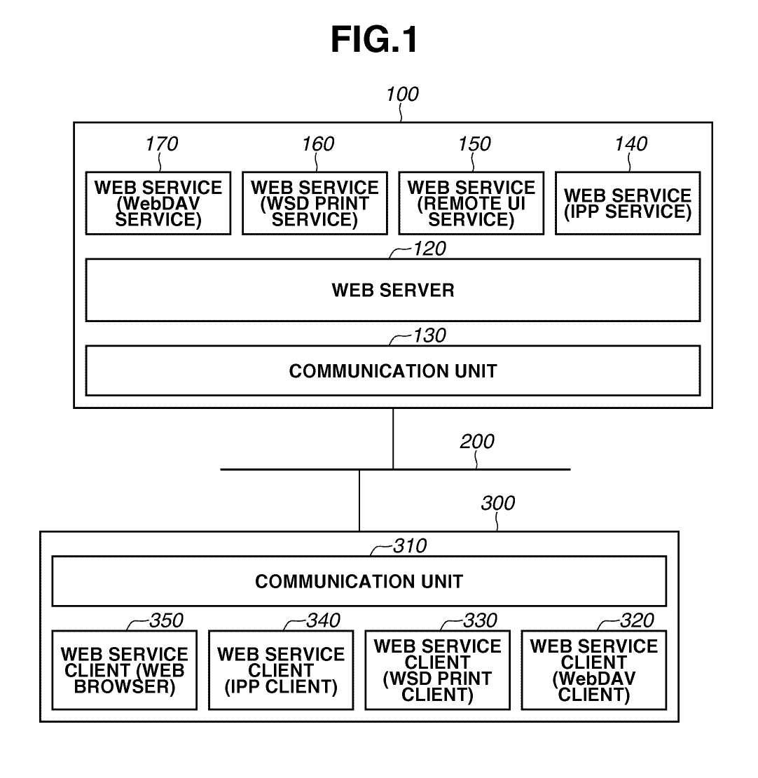

FIG. 1 is a diagram illustrating an overall configuration of a web server apparatus 100 and a web client apparatus 300 according to the first exemplary embodiment.

In FIG. 1, the web server apparatus 100 and the web client apparatus 300 are connected to each other via a network 200. The network 200 may be the Internet or a local area network (LAN).

The web server apparatus 100 includes a communication unit 130 for network communication, a web server 120 for providing a web server function, and web services 140, 150, 160, and 170. Each of the web services 140, 150, 160, and 170 provides a service by operating on the web server 120. Here, the “service” represents a function included in a web service such as the above-described Remote UI service and IPP service, and also a web distributed authoring and versioning (WebDAV) service. The web server 120 receives an HTTP request via HTTP communication, and allocates the request to the web service specified in the request, so that the web service provides the service thereof. Each of the web services 140, 150, 160, and 170 has a function equivalent to a common gateway interface (CGI) or a servlet, for example. Each of the web services 140, 150, 160, and 170 registers the web service determination condition (extension determination condition) in the web server 120. When the web server 120 receives a request corresponding to any of the extension determination conditions, the web server 120 allocates the request to the web server corresponding to the condition. This enables the web service to perform the processing specified in the HTTP request to provide the service thereof.

The web client apparatus 300 includes web service clients 320, 330, 340, and 350. The web service clients 320, 330, 340, and 350 include, for example, a web browser for displaying received hypertext markup language (HTML) data, a WebDAV client for storing/acquiring data in/from the storage of a web service, a WSD print for printing data using a print service provided by a web service, and an HTTP client. Each of the web service clients 320, 330, 340, and 350 has a function of communicating with a web service by using HTTP, requesting the web service to perform processing, receiving a result of the requested processing, and providing the received result to a user.

In order to request a web service to perform processing, each of the web service clients 320, 330, 340, and 350 transmits an HTTP request to the web server 120 by using a communication unit 310 of the web client apparatus 300. When receiving the request, the web server 120 analyzes the HTTP header part of the request, and determines whether the request corresponds to any of the extension determination conditions registered by the web services 140, 150, 160, and 170. If the web server 120 determines that the request corresponds to any of the registered extension determination conditions, the web server 120 executes a function for processing the corresponding web service. When the web server 120 executes the function for processing the web service, the web service performs the requested processing according to the HTTP operation or the HTTP body part of the received data as necessary, thereby providing the service.

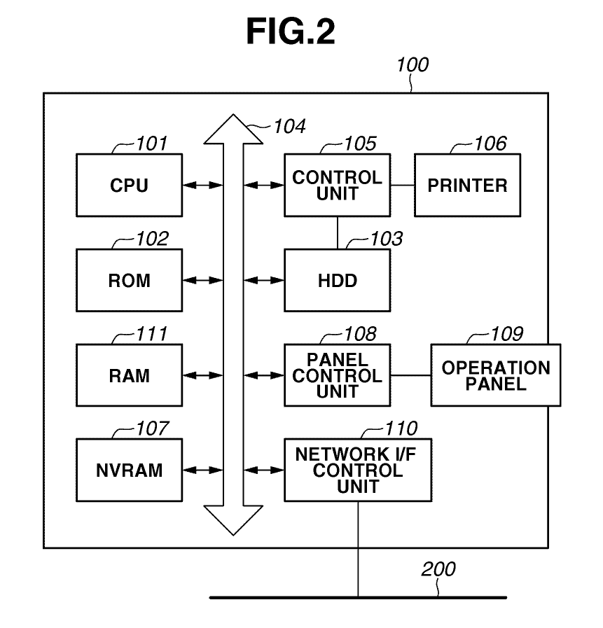

The web server apparatus 100 includes a read only memory (ROM) 102 and a hard disk drive (HDD) 103 illustrated in FIG. 2. A communication unit 130, the web server 120, and the web services 140, 150, 160, and 170 in the web server apparatus 100 are recorded in the ROM 102 and the HDD 103, and executed by a central processing unit (CPU) 101.

FIG. 2 is a block diagram illustrating an example of a hardware configuration of the web server apparatus 100 according to the first exemplary embodiment. This diagram illustrates the web server apparatus 100 having a printer function as a typical example. That is, the web server apparatus 100 is a printer. The web server apparatus 100 may be a multifunction peripheral having a scanner function (not illustrated). The web server apparatus 100 having a storage server function includes the CPU 101.

The CPU 101 comprehensively controls each unit connected to a system bus 104 by executing a program stored in the ROM 102 or the HDD 103. A random access memory (RAM) 111 functions as a main memory and a work area of the CPU 101. A control unit 105 of the web server apparatus 100 having the storage server function controls a printer 106 serving as a print engine or the HDD 103.

A software configuration of the first exemplary embodiment is realized by the CPU 101 of the web server apparatus 100 which executes a program stored in the ROM 102 or the HDD 103. A non-volatile random access memory (NVRAM) 107 stores various setting values for defining operations of the web server apparatus 100. A panel control unit 108 controls an operation panel 109 to display various information and receive an instruction from a user through the operation panel 109. A network interface (I/F) control unit 110 controls transmission and reception of data to and from the network 200.

The web client apparatus 300 also has the hardware configuration illustrated in FIG. 2. Each software illustrated in FIG. 1 can function when the CPU 101 executes a program stored in the ROM 102 or the HDD 103. In the first exemplary embodiment, it is assumed that the web client apparatus 300 is an information processing apparatus such as a general personal computer and a mobile terminal including a smart phone, and does not have an image forming function such as a printing function. Thus, the web client apparatus 300 is the information processing apparatus that does not include the printer 106 or the control unit 105.

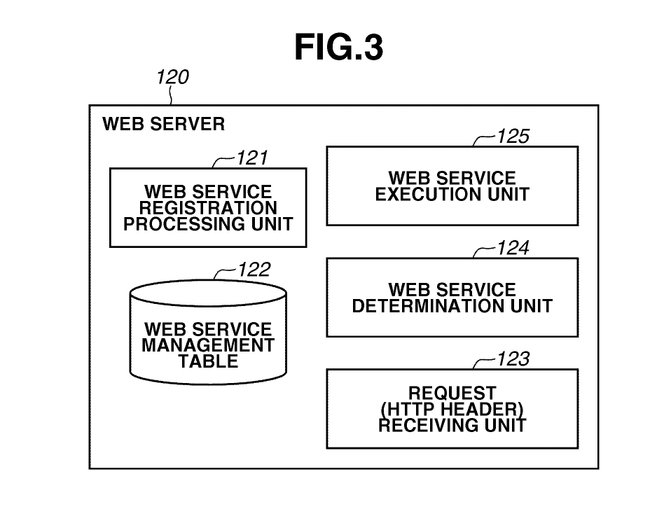

FIG. 3 is a diagram illustrating an internal module of the web server 120. The web server 120 includes a web service registration processing unit 121 for receiving a web service registration request from each of the web services 140, 150, 160, and 170. The web service registration request is a request for registering each of the web services 140, 150, 160, and 170 in the web server 120. When each of the web services 140, 150, 160, and 170 is registered, each of the registered web services 140, 150, 160, and 170 can execute a request received by the web server 120 from a web service client. The web service registration processing unit 121 has a function of recording an extension determination condition and a processing function for calling each of the web services 140, 150, 160, and 170 in a web service management table 122. The extension determination condition can be used to identify an appropriate web service even if any of the web services 140, 150, 160, and 170 that have transmitted the registration request have the same URL.

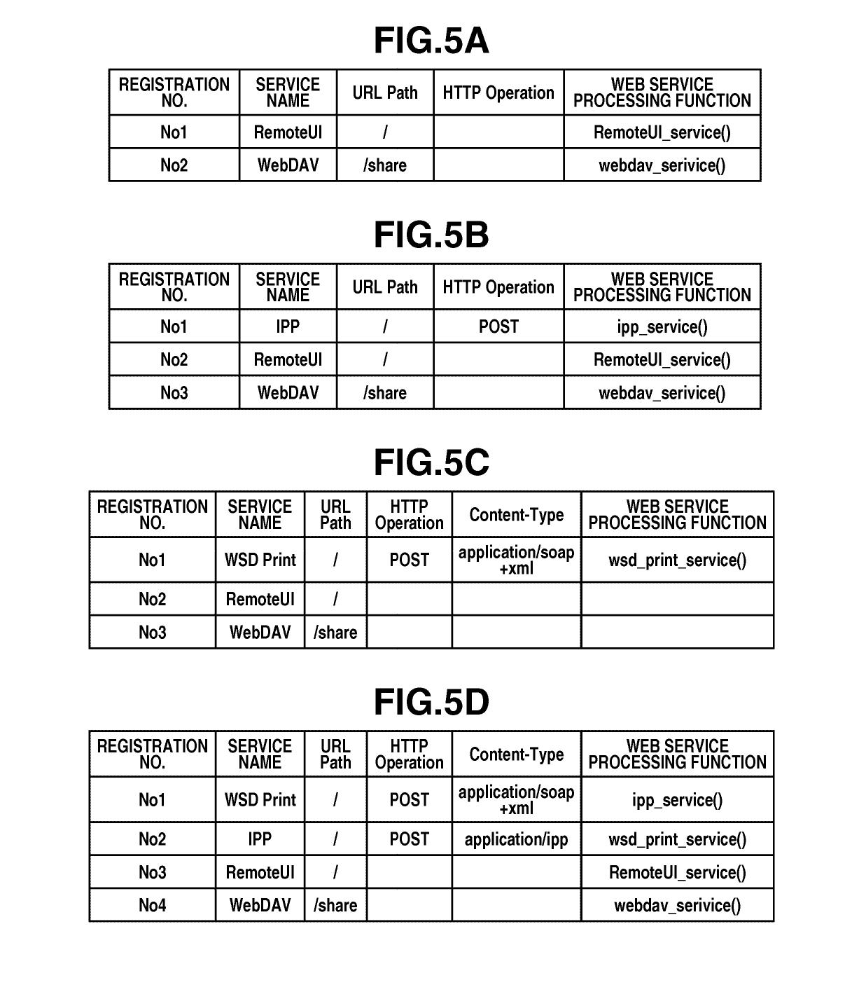

The web service management table 122 is structured as illustrated in FIGS. 5A, 5B, 5C, and 5D. In the first exemplary embodiment, an example will be described assuming that the web service management table 122 is generated for each port number by which the web service is executed. For example, if there are web services provided by a transmission control protocol (TCP) port number 80 and provided by a TCP port number 88, two web service management tables 122 are generated, one for the TCP port number 80, and the other for the TCP port number 88. Generating the web service management table 122 for each port number allows the web server 120 to find an appropriate web service in a faster manner.

A request (HTTP header) receiving unit 123 has a function of receiving the HTTP header part of a request transmitted to the web server 120 via the network. A web service determination unit 124 has a function of analyzing the HTTP header information received by the request (HTTP header) receiving unit 123, and identifying an appropriate web service according to the corresponding extension determination condition registered in the web service management table 122.

A web service execution unit 125 executes the web service identified by the web service determination unit 124. The web service execution unit 125 has a function of enabling HTTP communication with the identified web service. This HTTP communication function enables, for example, receiving an HTTP body part and transmitting an HTTP response according an HTTP protocol.

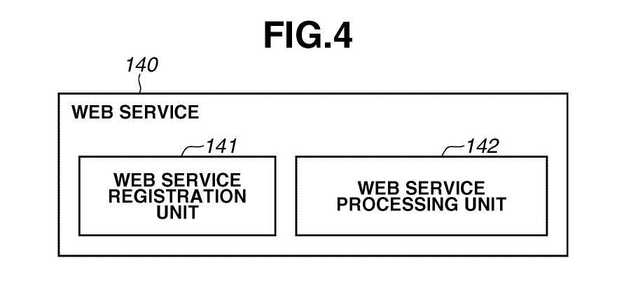

FIG. 4 is a diagram illustrating an internal module of the web service 140. A web service registration unit 141 determines whether the web service 140 is enabled or disabled when the web service 140 is activated. If the web service 140 is enabled, the web service registration unit 141 has a function of requesting the web service registration processing unit 121 to register the URL, the extension determination condition of the web service 140, and the processing function for the web service 140. A web service processing unit 142 has a function of performing processing of the web service 140. Particularly, the web service processing unit 142 executes the service processing function called by the web service execution unit 125. The web service processing unit 142 has a function of performing processing which is unique to each web service.

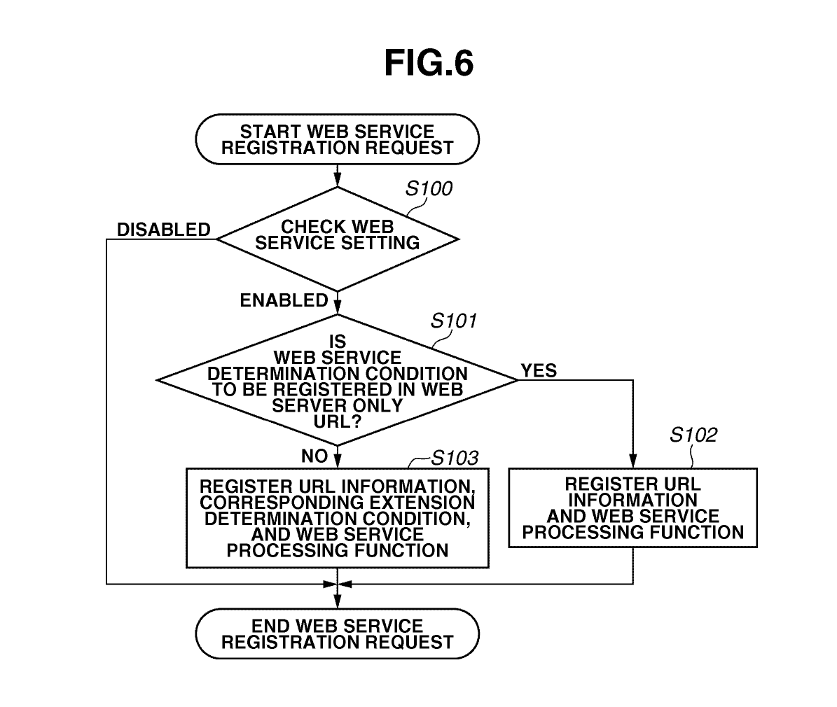

FIG. 6 is a flowchart illustrating specific processing executed by the web service registration unit 141. The web service registration unit 141 is stored in any of the storage units, the RAM 111, the ROM 102, and the HDD 103, and is executed by the CPU 101. In step S100, the web service registration unit 141 checks the settings of the web service 140 when the web service 140 is activated, and determines whether the web service 140 is enabled.

If the web service 140 is disabled (DISABLED in step S100), web service information does not need to be registered in the web server 120. Thus, the processing is ended without registering the web service information in the web server 120. If the web service 140 is enabled (ENABLED in step S100), the processing proceeds to step S101. In step S101, the web service registration unit 141 checks the web service execution determination condition to be registered in the web server 120. More specifically, the web service registration unit 141 determines whether to register only URL information or an extension determination condition in addition to the URL information. The extension determination condition may be an attribute unique to the web service 140, or may be set for the web service 140 by an administrator.

If only the URL information is registered (YES in step S101), then in step S102, the web service registration unit 141 registers the URL information and the web service processing function. If there is an extension determination condition in addition to the URL information (NO in step S101), the processing proceeds to step S103. In step S103, the web service registration unit 141 registers the URL information, the corresponding extension determination condition, and the web service processing function in the web server 120.

Here, the above-described URL information to be registered in the web server 120 will be additionally described. Generally, URL indicates a format defined by a request for comments (RFC) 1738. However, the URL information to be registered in the web server 120 represents a protocol (HTTP/HTTPS), the TCP port number by which the service is provided, and URL path information, instead of the information defined by the RFC 1738.

Further, any information specified in an HTTP header can be used as an extension determination condition. For example, the extension determination condition may be HTTP operation, Content-Type or User-Agent of an HTTP header, or HTTP extension header information beginning with “x-” as an extension to an application, which is defined by RFC 822. If the web service 140 registers its extension determination condition in the web server 120, the web server 120 does not call the web service 140 by using the processing function for the web service 140 unless both the URL information and the extension determination condition are matched even if the URL information is matched. Alternatively, the determination may be made based on two or more extension determination conditions. For example, if it is determined that another web service having the same URL path also has the same HTTP operation, the determination is further made based on the Content-Type. Thus, the web service 140 can register an extension determination condition in the web server 120, in addition to the URL.

Next, web service registration processing in the web server 120 will be described.

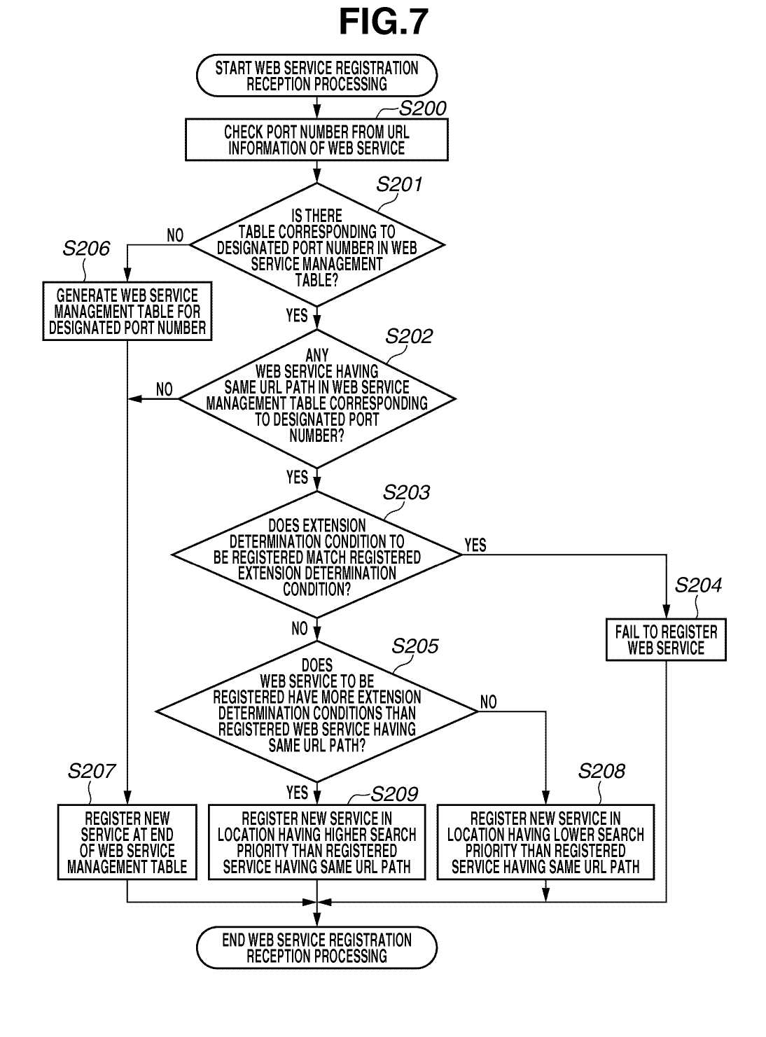

The web service registration processing unit 121 is stored in any of the storage units, the RAM 111, the ROM 102, and the HDD 103, and is executed by the CPU 101. Here, the flow of processing performed by the web service registration processing unit 121 illustrated in FIG. 7 will be described with reference to FIGS. 5A, 5B, 5C, and 5D.

First, FIG. 5A will be described. FIG. 5A illustrates the following state.

In the web service management table 122 illustrated in FIG. 5A, the Remote UI service 150 and the WebDAV service 170 are registered as services having the TCP port number 80. The Remote UI service 150 is registered only with “/” as the URL path. The WebDAV service 170 is registered only with “/share” as the URL path. Although the HTTP operation field is provided for registering an extension determination condition by the web server 120, the field is blank both for the Remote UI service 150 and the WebDAV service 170.

The flowchart illustrated in FIG. 7 will be described assuming that the web service management table 122 is as illustrated in FIG. 5A and the web service registration processing unit 121 receives a request to register the HTTP web service 140. Here, it is also assumed that the HTTP web service 140 has transmitted a registration request by specifying the TCP port number as “80” and the URL path as “/”, and the HTTP operation, which is one of the web service determination conditions, as “POST”.

In step S200, when receiving a web service registration request from the web service 140, the web service registration processing unit 121 checks the TCP port number of the URL information specified by the web service registration unit 141.

In step S201, the web service registration processing unit 121 determines whether there is a web service management table corresponding to the specified TCP port number in the web service management tables 122. If there is no web service management table corresponding to the specified TCP port number (NO in step S201), then in step S206, the web service registration processing unit 121 generates a new web service management table for the specified TCP port number. Subsequently, in step S207, the web service registration processing unit 121 registers the specified service name, URL path, and extension determination condition in the generated web service management table. Then, the processing is ended. If no extension determination condition is specified by the web service 140 in addition to the URL information, a field for an extension determination condition is blank and ignored. If a web service is registered with a blank field for an extension determination condition, at the time when the URL path is matched, the web service is identified as the web service to process the transmitted request. The configuration is such that even if web services are registered with a blank field for an extension determination condition and the extension determination condition included in the request does not match the registered extension determination condition, any of registered web services can be always executed.

Here, the IPP service 140 specifies the TCP port number 80. If the web service registration processing unit 121 determines that there is a web service management table corresponding to the TCP port number 80 in the web service management tables 122 (YES in step S201), the web service management table 122 illustrated in FIG. 5A is searched. After the web service management table 122 for the TCP port number 80 has been found, then in step S202, the web service registration processing unit 121 determines whether the same URL path as that of the web service registration request is registered in this web service management table. That is, the web service registration processing unit 121 checks whether a web service having the same URL path is registered. If a web service having the same URL path is not registered (NO in step S202), then in step S207, the web service registration processing unit 121 registers information of a new service to be registered this time at the end of the web service management table 122. Here, since the IPP service 140 has the URL path “/”, the URL path is the same as that of the Remote UI registered in No. 1 of the web service management table 122 illustrated in FIG. 5A. Accordingly, the web service registration processing unit 121 determines that the same URL path as that of the web service registration request is already registered (YES in step S202), and the processing proceeds to step S203.

If the same URL path is registered (YES in step 202), then in step S203, the web service registration processing unit 121 performs a comparison using the extension determination condition. In this example, since the HTTP operation as the extension determination condition is provided in the web server 120, the web service registration processing unit 121 compares the HTTP operation of the Remote UI service 150 with the HTTP operation to be registered by the IPP service 140. For the Remote UI service 150, the HTTP operation is not specified as illustrated in FIG. 5A. On the other hand, the IPP service 140 specifies “POST”. As a result of the comparison, the extension determination conditions of the IPP service 140 and the Remote UI service 150 do not match each other (NO in step S203), and the registration of the IPP service 140 is therefore permitted. In such a manner, if the web service registration processing unit 121 determines that the received extension determination condition does not match the extension determination condition registered corresponding to the same URL in the web service management table 122, the web service 140 is registered in the web service management table 122. When the web service 140 has been registered in the web service management table 122, the URL, the corresponding extension determination condition, the web service processing function, and the web service name are associated with one another as illustrated in FIG. 5B. If the web service determination conditions of the IPP service 140 and the Remote UI service 150 match each other as a result of the comparison of the extension web service determination conditions (YES in step S203), the processing proceeds to step S204. In step S204, the web service registration processing unit 121 does not register the web service 140, and the processing is ended.

Next, processing for checking the registration priority of web services and then actually registering the web service 140 in the web service management table 122 will be described. In step S205, the web service registration processing unit 121 compares the number of extension determination conditions of the web service 140 to be newly registered this time with the number of extension determination conditions of the registered web service 150 having the same URL path. This comparison is made because when the web service determination unit 124 searches for a web service corresponding to the extension determination condition of a request, the web service determination unit 124 checks the web services in the web service management table 122 in ascending order of registration number to determine whether there is a web service corresponding to the request. Therefore, a web service having a stricter condition needs to be registered with a smaller registration number in the web service management table 122 than a web service having a less strict condition. Otherwise, the web service having a less strict condition may be searched for first, since the number of extension determination conditions thereof is less than that of the web service having a stricter condition. This may cause the web service having a stricter condition to remain unsearched due to the larger number of extension determination conditions.

Based on the comparison, one extension determination condition is set for the IPP service 140, whereas no extension determination condition is set for the Remote UI service 150. In step S209, since the IPP service 140 needs to be given a higher search priority than the Remote UI service 150, the IPP service 140 is inserted and registered in the registration No. 1. As a result, the registration numbers of the Remote UI service 150 and the WebDAV service 170 are shifted by one from the registration numbers in the table illustrated in FIG. 5A to the registration numbers in the table illustrated in FIG. 5B. If the number of the extension determination conditions of the web service 140 to be newly registered is less than or equal to that of the registered web service 150 (NO in step S205), the processing proceeds to step S208. In step S208, the web service registration processing unit 121 registers the web service 140 with a registration number that follows the registration number of the web service 150 having the same URL.

Here, an example will be described where the web service management table 122 is as illustrated in FIG. 5C and the HTTP service 140 is to be registered. In FIG. 5C, the WSD Print service 160, the Remote UI service 150, and the WebDAV service 170 are registered as the services having the TCP port number 80 in the web service management table 122. The WSD print service 160 and the Remote UI service 150 are registered with “/” as the URL path, whereas the WebDAV service 170 is registered only with “/share” as the URL path. In the web service registration table 122 illustrated in FIG. 5C, the HTTP operation field and the Content-Type field as extension determination conditions are provided by the web server 120. For the WSD Print service 160, “POST” and “application/soap+xml” are specified as the HTTP operation and the Content-Type, respectively. For the Remote UI service 150 and the WebDAV service 170, no extension determination condition is specified.

In such a state, it is assumed that the HTTP web service (IPP service) 140 has transmitted a registration request by specifying the TCP port number as “80”, the URL path as “/”, the HTTP operation as “POST”, and the Content-Type as “application/ipp”. In this case, in step S205 in the flowchart illustrated in FIG. 7, the web service registration processing unit 121 compares the number of the extension determination conditions of the web service 140 to be newly registered with that of the registered web services 150 and 160 having the same URL path. As a result, since the HTTP operation and the Content-Type are specified as the extension determination conditions for both the IPP service 140 and the WSD Print service 160, the number of the extension determination conditions is equal to each other. Consequently, the IPP service 140 is registered in the registration number that follows the registration number of the WSD Print service 160, and thereby the web service management table 122 is updated as illustrated in FIG. 5D.

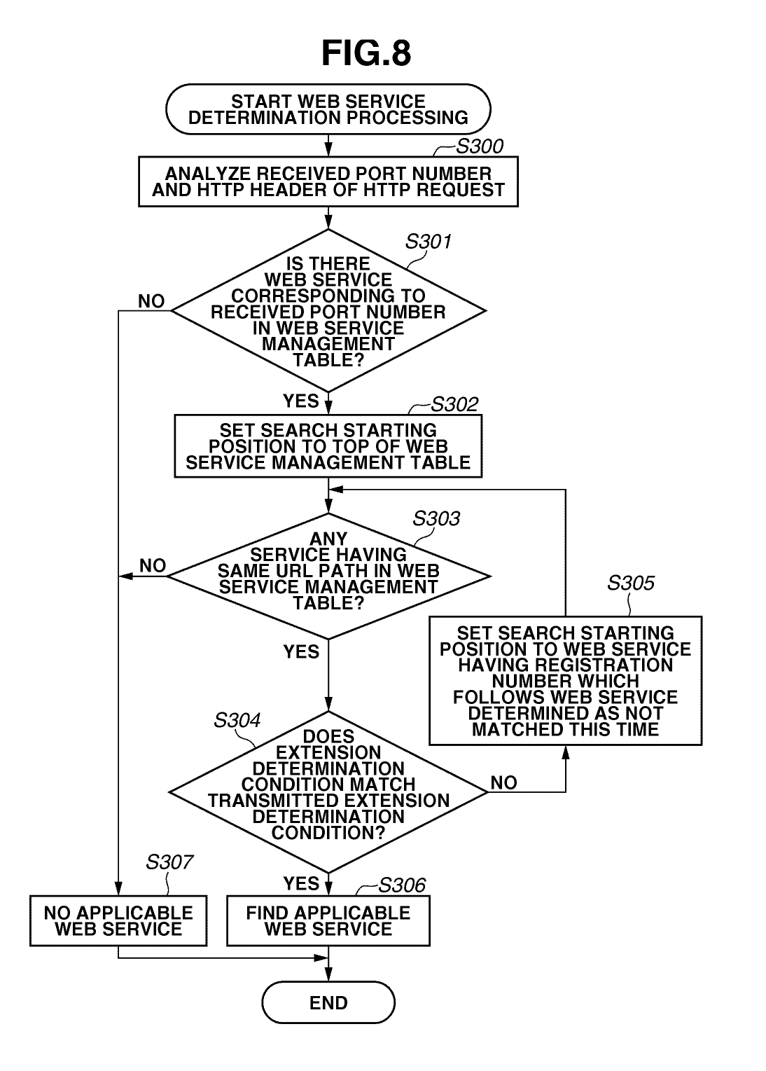

Lastly, processing executed by the web service determination unit 124 will be described with reference to FIG. 8. The web service determination unit 124 is stored in any of the storage units, the RAM 111, the ROM 102, and the HDD 103, and is executed by the CPU 101. The web service determination unit 124 has a function of allocating requests to the respective web services.

In step S300, when receiving a request to a web service, the request receiving unit 123 requests the web service determination unit 124 to determine the web service. The web service determination unit 124 acquires from the request receiving unit 123 the receiving TCP port number where the HTTP request has been received, and the HTTP header information of the received request. The web service determination unit 124 analyzes the HTTP header information.

In step S301, the web service determination unit 124 checks whether there is a web service management table corresponding to the receiving TCP port number in the web service management table 122. If there is no web service management table corresponding to the TCP port number (NO in step S301), the processing proceeds to step S307. In step S307, the web service determination unit 124 determines that the corresponding web service does not exist. On the other hand, if there is a web service management table corresponding to the receiving TCP port number (YES in step S301), the processing proceeds to step S302. In step S302, the web service determination unit 124 sets a service search starting position to the top of the registration numbers (i.e., the registration No. 1) in the detected web service management table.

In step S303, the web service determination unit 124 searches for any registered service having the same URL path as that of the received HTTP request, starting from the search starting position in the selected web service management table. If there is no registered service having the same URL path (NO in step S303), then in step S307, the web service determination unit 124 determines that there is no web service that can process the request. Subsequently, the processing is ended. If the web service determination unit 124 has detected a registered service having the same URL path (YES in step S303), the processing proceeds to step S304. In step S304, the web service determination unit 124 checks whether the extension determination condition of the detected web service matches the extension determination condition transmitted with the request. If these extension determination conditions do not match each other (NO in step S304), the processing proceeds to step S305. In step S305, the web service determination unit 124 sets a search starting position in the web service management table 122 to the location of the web service having a registration number that follows the registration number of the web service determined not to be matched this time. Then, the processing returns to step S303 and step S304, so that the web service determination unit 124 continues to search for the web service having the same URL path and the matched extension determination condition. If the web service determination unit 124 determines that the extension determination condition matches the transmitted extension condition (YES in step S304), then in step S306, the web service determination unit 124 determines that the web service corresponding to the request has been found.

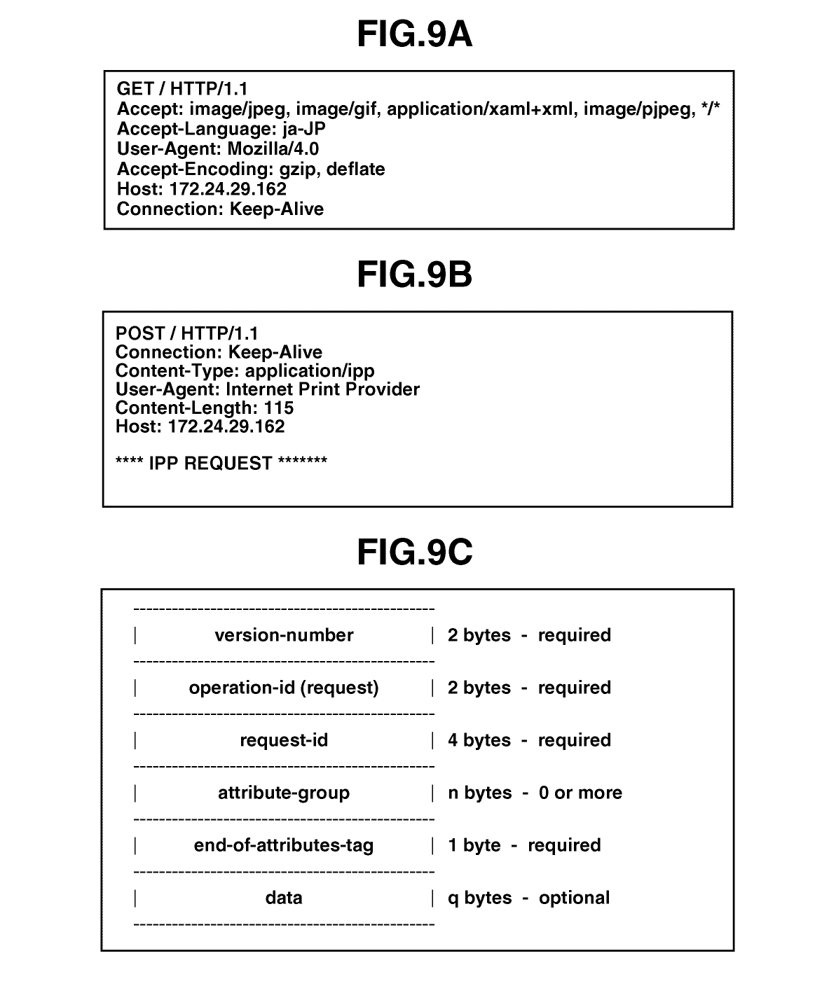

Now, a specific example of processing by the web service determination unit 124 will be described with reference to the flowchart illustrated in FIG. 8. In this processing, the web client apparatus 300 transmits a request to the web server 120, and the web service determination unit 124 specifies the corresponding web service. It is assumed here that the web service management table 122 is as illustrated in FIG. 5B. The system configuration illustrated in FIG. 1, and examples of request data to the web service illustrated in FIGS. 9A, 9B, and 9C are used for this processing.

In order for a user to connect to the web service (the Remote UI service 150), the user inputs the URL information of the Remote UI service 150 in a URL input field of the web service client 350 (hereinafter referred to as a web browser). The URL information to be input is, for example, http://172.24.29.162/. This URL information may not necessarily be input in the input field of the web browser 350. The URL information may be input by selecting the information registered as a bookmark in the web browser 350. The information “172.24.29.162” indicates the IP address of the web server apparatus 100. A combination of “http://” and the IP address enables each of the web service clients 320, 330, 340, and 350 to access the web server 120. The web browser 350 identifies the web server 120 based on the input URL information, and transmits an HTTP request for acquiring HTML data, which is illustrated in FIG. 9A. In this case, the HTTP request includes only an HTTP header, that is, an HTTP body is not included in the HTTP request.

When receiving the HTTP header of the request data illustrated in FIG. 9A, the request receiving unit 123 requests the web service determination unit 124 to identify the corresponding web service. The web service determination unit 124 identifies the web service based on the web service determination processing illustrated in FIG. 8. According to the request (FIG. 9A) from the web browser 350, the URL path is “/” and the HTTP operation is “GET”. Therefore, the web service determination unit 124 determines this request as a processing request to the Remote UI service 150 of the registration No. 2 as a result of a search through the web service management table 122 illustrated in FIG. 5B. Accordingly, the Remote UI service 150 is executed, and a processing result thereof is provided to the web browser 350 as a response. The web browser 350 acquires an HTML file as the processing result from the Remote UI service 150, and displays the received HTML file.

Further, another specific example will be described where a user is to connect to the IPP service 140. The IPP service 140 is the Internet Printing Protocol, and the versions 1.0, 1.1, 2.0, 2.1, and 2.2 are defined by the RFC. The IPP defines commands for checking the status or capability of a printer, issuing an instruction to print a specified document, and checking the job status. These commands are stored in the HTTP body part. In other words, the operation of the IPP cannot be identified with the HTTP header.

If the user uses the IPP service 140 to check printer capability information, the user needs to specify the URL of the IPP service 140 in the IPP client 340. The URL of the IPP service 140 can be directly specified by the user. The URL of the IPP service 140 can also be searched for via a network by using a service search technique such as a multicast domain name system (mDNS) and a service location protocol (SLP). Based on the search result, the URL of the IPP service 140 can be acquired.

When the user searches for and acquires the URL information of the IPP service 140 or directly inputs the URL in the IPP client 340, the user is connected to the specified URL. It is assumed here that the URL is, for example, http://172.24.29.162/. This URL is the same as that of the Remote UI service 150 described above. Registering the web service 140 in this state causes both the web service 140 and the Remote UI service 150 to be registered with the same URL. Then, the IPP client 340 transmits a request including HTTP header information and an HTTP body part illustrated in FIG. 9B, which includes a command indicating the details of the request to the IPP service 140.

When receiving the HTTP header of the request data illustrated in FIG. 9B, the request receiving unit 123 requests the web service determination unit 124 to identify the corresponding web service. The web service determination unit 124 identifies the web service based on the web service determination processing illustrated in FIG. 8. According to the request (FIG. 9B) from the web browser 350, the URL path is “/” and the HTTP operation is “POST”. Therefore, the web service determination unit 124 determines the request as a processing request to the IPP service 140 of the registration No. 1 based on a search through the web service management table 122 illustrated in FIG. 5B. Then, the IPP service 140 is executed. The IPP service 140 checks the details of the request thereto by receiving the IPP request data included in the HTTP body part.

FIG. 9C illustrates a data format of the IPP request data illustrated in FIG. 9B.

The IPP request is defined by RFC 2910, and an instruction to the IPP service 140 is specified in the operation-id field. An instruction to the IPP service is, for example, a Print-Job request for performing a print operation, or a Get-Printer-Attributes request for acquiring printer attributes. “0x0002” specified in the operation-id field indicates the Print-Job request, whereas “0x000B” specified in the operation-id field indicates the Get-Printer-Attributes request.

When receiving the request data in the format illustrated in FIG. 9C, the IPP service 140 executes the instruction specified by the command included in the operation-id field. For example, if the instruction is the Get-Printer-Attributes request for acquiring printer attributes, the IPP service 140 responds to the IPP client 340 with the printer capability information. If the instruction is the Print-Job request, the IPP service 140 receives print data included in the data field of the request, and causes the printer 106 to perform printing based on the print data.

When the IPP service 140 completes the processing specified by the IPP request data illustrated in FIG. 9B, the IPP service 140 transmits a response to the requested processing to the IPP client 340 by storing the response in the HTTP body part in a format according to the IPP standard.

The IPP client 340 acquires a result of the request from the data stored in the HTTP body part of the received response, and ends the communication with the IPP service 140.

As described above, according to the first exemplary embodiment, even if a plurality of web services having the same URL operates on a single web server, the web server can identify which web service to call, based on a received HTTP request. Since the HTTP request may differ depending on each web service client that transmits the request, the web server can identify the web service from among the plurality of the web services having the same URL. Consequently, the user needs to remember only one URL. This allows a variety of web services to be executed while maintaining usability.

Another exemplary embodiment of the present subject matter will be described. The above-described exemplary embodiment of the present subject matter is realized by executing the processing, in which software (program) for implementing the functions of the above-described exemplary embodiment is supplied to a system or an apparatus through a network or various storage media, and the program is read out and executed by a computer (or a CPU or a micro-processing unit (MPU)) in the system or the apparatus.

Thus, even if a plurality of web services having the same URL operates on a single web server, the web server can identify which web service to call, based on a received HTTP request.

While the present subject matter has been described with reference to exemplary embodiments, it is to be understood that the subject matter is not limited to the disclosed exemplary embodiments. The scope of the following claims is to be accorded the broadest interpretation so as to encompass all such modifications and equivalent structures and functions.

This application claims the benefit of Japanese Patent Application No. 2013-013324 filed Jan. 28, 2013, which is hereby incorporated by reference herein in its entirety.

What is claimed is:

1. A web server apparatus comprising:
a reception unit configured to receive a registration request from a web service and receive a URL and an extension determination condition used to identify the web service;
a registration unit configured to, if the same URL as the received URL is already registered in a web service management table, register in the web service management table a correspondence between the received URL and the received extension determination condition and a function for calling the web service in association with each other as information of the web service that has transmitted the registration request, after determining that the received extension determination condition is not the same as an extension determination condition registered in the web service management table; and
a request unit configured to, if a request is received and if the same correspondence as a correspondence between a URL and an extension determination condition included in the request is registered in the web service management table, call a web service for processing the request by using a function registered in association with the correspondence.

2. The web server apparatus according to claim 1, wherein the registration unit does not register the web service that has transmitted the registration request, if the registration unit determines that the received extension determination condition is the same as the extension determination condition registered in the web service management table.

3. The web server apparatus according to claim 1, wherein when the registration unit registers the web service that has transmitted the registration request, the registration unit determines a priority level of the web service and registers the web service in the web service management table according to the priority level.

4. The web server apparatus according to claim 1, wherein when the registration unit registers the web service that has transmitted the registration request, the registration unit compares the number of the extension determination conditions registered corresponding to the same URL as the received URL registered in the web service management table with the number of the received extension determination conditions, and if the number of the received extension determination conditions is greater, the registration unit registers the web service that has transmitted the registration request in the web service management table with a higher priority.

5. The web server apparatus according to claim 1, wherein the web service management table is stored for each port number, and
wherein the registration unit identifies a port number of the web service based on the received URL, and registers the web service in the web service management table for the identified port number.

6. The web server apparatus according to claim 1, wherein the web service that has transmitted the registration request is an Internet printing protocol (IPP) service.

7. The web server apparatus according to claim 1, wherein the web server apparatus is a printer.

8. A method for controlling a web server apparatus, the method comprising:
receiving a registration request from a web service, and receiving a URL and an extension determination condition used to identify the web service;
registering in a web service management table, if the same URL as the received URL is already registered therein, a correspondence between the received URL and the received extension determination condition and a function for calling the web service in association with each other as information of the web service that has transmitted the registration request, after determining that the received extension determination condition is not the same as an extension determination condition registered in the web service management table; and
calling, if a request is received and if the same correspondence as a correspondence between a URL and an extension determination condition included in the request is registered in the web service management table, a web service for processing the request by using a function registered in association with the correspondence.

9. The method according to claim 8, further comprising not registering the web service that has transmitted the registration request, if the received extension determination condition is the same as the extension determination condition registered in the web service management table.

10. The method according to claim 8, further comprising, when registering the web service that has transmitted the registration request, determining a priority level of the web service and registering the web service in the web service management table according to the priority level.

11. The method according to claim 8, further comprising, when registering the web service that has transmitted the registration request, comparing the number of the extension determination conditions registered corresponding to the same URL as the received URL registered in the web service management table with the number of the received extension determination conditions, and if the number of the received extension determination conditions is greater, registering the web service that has transmitted the registration request in the web service management table with a higher priority.

12. The method according to claim 8,
wherein the web service management table is stored for each port number, and
wherein the method further comprises identifying a port number of the web service based on the received URL, and registering the web service in the web service management table for the identified port number.

13. The method according to claim 8, wherein the web service that has transmitted the registration request is an Internet printing protocol (IPP) service.

14. The method according to claim 8, wherein the web server apparatus is a printer.

15. A storage medium storing a program that causes a web server apparatus to execute the method according to claim 8.
